(19) United States
(12) Patent Application Publication
(10) Pub. No.: US 2007/0046073 A1
(43) Pub. Date: Mar. 1, 2007

(54) Headliner with improved attachment structure

(76) Inventors: Adam Michael Ludwig, Ann Arbor, MI (US); Anica Cherron Felton, Canton, MI (US)

Correspondence Address: GIFFORD, KRASS, GROH, SPRINKLE,;ANDERSON & CITKOWSKI, P.C., P.O. BOX 7021, TROY, MI, 48007-7021, US

(21) Appl. No.: 11/209,428

(22) Filed: Aug. 23, 2005

(51) Int. Cl. B60J 7/00

(52) U.S. Cl. 296/214

(57) ABSTRACT

A headliner includes a substrate defining an inner surface. A cup extends outwardly from the inner surface of the substrate. The cup defines an end wall spaced apart from the substrate. The cup has a tubular side wall extending between the end wall and the inner surface of the substrate. The end wall defines an aperture for receiving a fastener therethrough for securing the headliner to an inner surface of a vehicle roof. The side wall defines a first slot for receiving and engaging a portion of the fastener therethrough to maintain the fastener within the aperture of the end wall.

### BACKGROUND OF THE INVENTION

1. Field of the Invention

The invention relates to a headliner for an automotive vehicle. More specifically, the invention relates to an improved attachment structure allowing the headliner to be fixedly secured to the roof of the vehicle.

2. Description of the Related Art

Automotive vehicles include a passenger compartment and typically include a rigid roof for covering the passenger compartment. Rigid roofs are usually made of sheet steel panels and include rigid support members extending along an inner surface of the roof. Further, wiring and ductwork are routed along the roof. Headliners are used to cover the inner surface of the roof, support members, wiring and ductwork providing an aesthetically pleasing appearance.

Typically, push-type fasteners are inserted through corresponding holes in the headliner and support members to secure the headliner to the roof. Metal brackets are also commonly used to allow attachment of the headliner along an area of the roof not having a support member. The support members and the brackets maintain the headliner in spaced relation with respect to the roof.

The use of brackets, however, adds weight and cost to the vehicle. Accordingly, it remains desirable to provide an improved means of attaching a headliner to a roof of an automotive vehicle.

### SUMMARY OF THE INVENTION

According to one aspect of the invention, a headliner is provided for covering an inside surface of a rigid roof structure of an automotive vehicle, wherein the roof includes an aperture. The headliner includes a substrate having an inner surface. A cup extends outwardly from the inner surface of the substrate. The cup defines an end wall spaced apart from the substrate. The cup has a side wall extending between the end wall and the inner surface of the substrate. The cup has an aperture for receiving a fastener, so that the fastener protrudes outwardly from the end wall to lockingly engage the aperture formed in the vehicle roof.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a cross sectional view of a headliner according to one embodiment the present invention;

FIG. 2 is a perspective view of a cup shaped member of the headliner disclosed in FIG. 1; and

FIG. 3 is a perspective view of the cup shaped member according to a second embodiment of the invention.

### DETAILED DESCRIPTION OF THE INVENTION

The present invention provides a headliner for covering an inside surface of a rigid roof structure of an automotive vehicle. Specifically, the invention provides an attachment structure allowing the headliner to be fixedly secured to the inside surface of the roof without the need for metal brackets between the headliner and the inside surface of the roof.

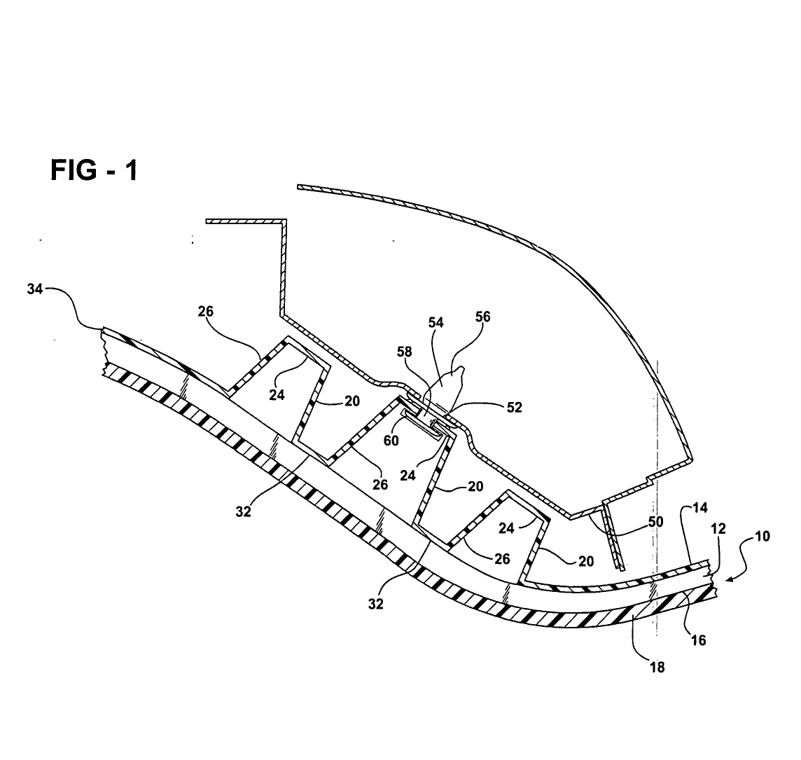

Referring to FIG. 1, a headliner for covering the inside surface of the roof is generally indicated at 10. The headliner 10 includes a substrate 12 defining an inner surface 14 and an opposite outer surface 16. Preferably, the substrate 12 is made from a polymer material and formed in a molding process to define the overall shape of the headliner 10. A trim layer 18 may be fixedly secured to the outer surface 16 of the substrate by conventional methods, such as using adhesives or a molding in-place process. The trim layer 18 may also include a foam backing.

A plurality of cups 20 extend outwardly from the inner surface 14 of the substrate 12. Each cup 20 has a generally frustoconical shape. Each cup 20 has an end wall 24 spaced apart from the inner surface 14. Each cup 20 has a tubular side wall 25 that extends between the end wall 24 and the inner surface 14. The end wall 24 of at least one of the cups 20 defines a circular aperture 26 for receiving a fastener 54 therein. It should, however, be appreciated that the aperture can have any suitable shape depending on the type of fastener used. A first slot 28 is formed in the side wall 25. The first slot 28 is positioned circumferentially along a portion of the side wall 25. A second slot 30 is formed in both the end wall 24 and the side wall 25. The second slot 30 is continuous with the aperture 26 and the first slot 28. The second slot 30 is positioned orthogonally with respect to the first slot 28.

The end wall 24 has an outer surface 29 that generally abuts the roof when assembled to the vehicle. Preferably, a pair of ribs 31 extends outwardly from the outer surface 29. The ribs 31 are positioned on opposite sides of the aperture 26. The ribs 31 abut the roof during assembly of the headliner 10 to the vehicle. The ribs 31 also provide increased rigidity to the end wall 24.

The cups 20 are connected at the side wall 25 by a web 32 allowing the cups to be assembled to the substrate 12 as a unit or attachment structure 34. Preferably, the entire attachment structure 34 is made of a polymer material, such as polypropylene, and formed in a molding process, such as vacuum forming or injection molding. The polymer material may be reinforced using glass fiber to provide increased rigidity. The attachment structure 34 is fixedly secured to the inner surface 14 of the substrate 12 by conventional methods, such as using adhesives, heat staking or molding in-place.

The roof 50 of the vehicle is typically made from stamped sheet steel, as known y those of ordinary skill in the art. A hole 52 is provided in the roof 50 for receiving and retaining the fastener 54 therein. The fastener 54 includes an engaging portion 56 that is collapsible upon insertion through the hole 52 in the roof 50. The engaging portion 56 springs back to its original shape after passing through the hole 52 to prevent removal therefrom. A boss 58 extends axially from the engaging portion 56. A disc 60 extends radially outwardly from an end of the boss 58. The disc 60 is axially spaced apart from the engaging portion 56.

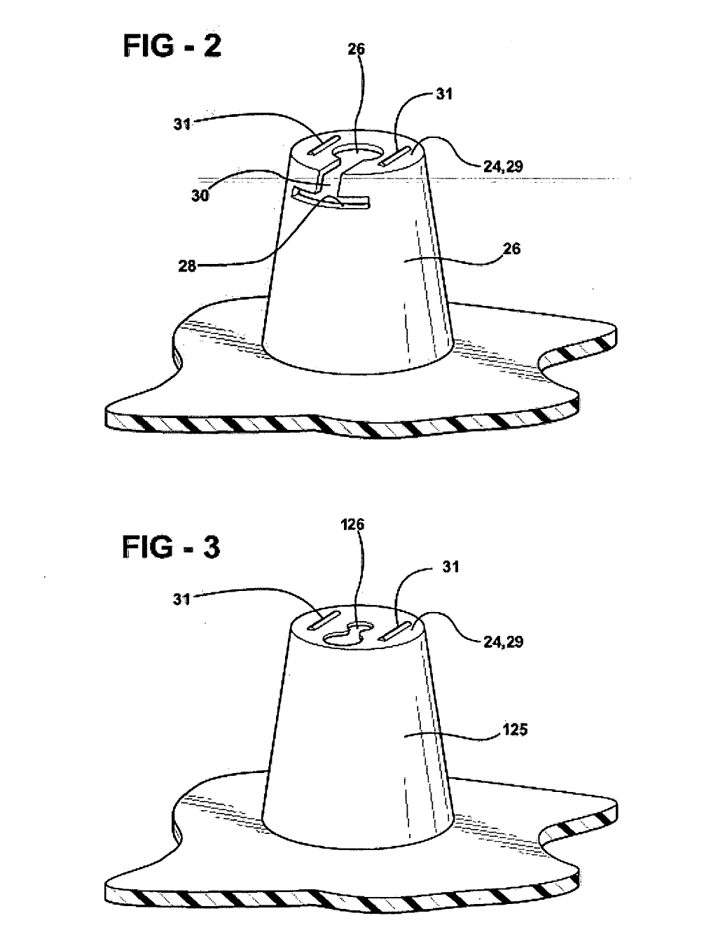

As best shown in FIG. 2, the fastener 54 is assembled to the cup 20 by first aligning the disc 60 with the first slot 28 and aligning the boss 58 with the second slot 30. Once aligned, the fastener 54 is inserted into the first 28 and second 30 slot until the boss 58 is seated in the aperture 26 in the end wall 24. Preferably, the second slot 30 has a width slightly smaller than the diameter of the boss 58 so as to create a press-fit condition as the boss 58 is inserted through the second slot 30. A portion of the disc 60 remains in the first slot 28 to axially constrain the fastener 54 relative to the cup 20.

The headliner 10, with the fastener 54 extending outwardly from the outer surface 29 of the cup 20, is placed along the inner surface of the roof 50. The engaging portion 56 of the fastener 54 is aligned with the hole 52 in the roof 50. The headliner 10 is pressed again the roof 50 so that the fastener 54 enters the hole 52. The fastener 54 lockingly engages the hole 52 and retains the headliner 10 against the inner surface of the roof 50. Preferably, the headliner 10 includes a plurality of cups 20 supporting a plurality of fasteners 54 distributed along a substantial portion of the inner surface 14 of the substrate 12, so that the headliner 10 is securely held in position along the roof 50 of the vehicle.

The plurality of cups 20 also functions to absorb energy due to contact between an occupant and the headliner 10. Each of the cups 20 has a predetermined size and shape. Specifically, the angles between the end wall 24 and side wall 25, the diameter or width of the end wall 24, the height of the side wall 25, and the thickness of the cup walls 24, 25 are all predetermined to absorb energy associated with an impact between the occupant and the headliner 10 during a sudden vehicle deceleration.

In FIG. 3, an alternative embodiment of the invention is shown, wherein the cup includes a key-hole or kidney-shaped aperture 126 for receiving the fastener therein. The slots 28, 30 from the previous embodiment are omitted to provide a stronger side wall 125.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

I claim:

1. A headliner for covering an inside surface of a vehicle roof, wherein the roof includes an aperture said headliner comprising:
a substrate having an inner surface;
a cup extending outwardly from said inner surface of said substrate, said cup defining an end wall spaced apart from said substrate, said cup having a side wall extending between said end wall and said inner surface of said substrate, said cup having an aperture for receiving a fastener, so that said fastener protrudes outwardly from said end wall to lockingly engage the aperture formed in the vehicle roof.

2. A headliner as set forth in claim 1, wherein said side wall defines a first slot for receiving and engaging a portion of the fastener therethrough to maintain the fastener within said aperture of said end wall.

3. A headliner as set forth in claim 1, wherein said cup has a frustoconical shape.

4. A headliner as set forth in claim 1, wherein said cup includes a second slot that is continuous with said aperture in said end wall and said first slot in said side wall.

5. A headliner as set forth in claim 4, wherein said second slot extends orthogonally from said first slot.

6. A headliner as set forth in claim 1, wherein said cup is vacuum formed from plastic.

7. A headliner as set forth in claim 1, wherein said cup is injection molded from plastic.

8. A headliner as set forth in claim 3, wherein said second slot extends orthogonally from said first slot.

9. A headliner as set forth in claim 1, wherein said plurality of cups is vacuum formed from plastic.

10. A headliner as set forth in claim 9, wherein said side wall is substantially tubular shaped.

11. An attachment structure for attaching a headliner having an inner surface to a vehicle roof, said attachment structure comprising:
a support wall adapted to be fixedly secured to the inner surface of the headliner;
a plurality of cups extending outwardly from said support wall, each of said plurality of cups having an end wall spaced apart from said support wall, each of said plurality of cups having a side wall extending between said end wall and said support wall, said end wall of at least one of said plurality of cups having an aperture for receiving a fastener, so that said fastener protrudes outwardly from said end wall to lockingly engage the aperture formed in the vehicle roof.

12. An attachment structure as set forth in claim 11, wherein said at least one of said plurality of cups has a frustoconical shape.

13. An attachment structure as set forth in claim 11, wherein said at least one of said plurality of cups includes a second slot that is continuous with said aperture in said end wall and said first slot in said side wall.

14. A headliner as set forth in claim 11, wherein said side wall of said at least one of said plurality of cups defines a first slot for receiving and engaging a portion of the fastener therethrough to maintain the fastener within said aperture of said end wall.
